(19) United States
(12) Patent Application Publication
(10) Pub. No.: US 2022/0223095 A1
(43) Pub. Date: Jul. 14, 2022

(54) DISPLAY PANEL, AND METHOD AND DEVICE FOR PIXEL COMPENSATION THEREOF

(71) Applicant: TCL CHINA STAR OPTOELECTRONICS TECHNOLOGY CO., LTD., Shenzhen, Guangdong (CN)

(72) Inventors: Yonglei ZHANG, Shenzhen, Guangdong (CN); Tao HE, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/423,859

(22) PCT Filed: May 31, 2021
(86) PCT No.: PCT/CN2021/097137

§ 371 Date: Jul. 17, 2021

(30) Foreign Application Priority Data
Jan. 11, 2021 (CN) 202110029966.8

(51) Int. Cl. G09G 3/20; G09G 3/36

(52) U.S. Cl. CPC G09G 3/2074; G09G 3/36; G09G 2310/08; G09G 2300/0443; G09G 2320/0233; G09G 2320/0247

(57) ABSTRACT

A display panel, and a method and a device for pixel compensation thereof are provided. The method includes receiving a signal of a frame of image, obtaining grayscale compensation data, and compensating the grayscale data. In the image in a same frame, polarities of grayscale compensation data of two adjacent sub-pixels are opposite. In a time period unit, respective polarities of high grayscale compensation data and low grayscale compensation data of each of the sub-pixels remain symmetrical.

### FIELD OF INVENTION

The present disclosure relates to the technical field of display, and particularly to a display panel, and a method and a device for pixel compensation thereof.

### BACKGROUND

With the development of display technology, sizes of liquid crystal display screens are getting larger. For large-size liquid crystal display screens, viewing angle parameters are particularly important. Among different types of liquid crystal display panels, vertical alignment (VA) mode liquid crystal display panels have obvious disadvantages in viewing angles. A large-size VA type liquid crystal display panel generally adopts an eight-domain pixel structure, or adopts a four-domain pixel structure with view angle compensation (VAC) technology to improve a brightness effect when viewed from a side thereof.

Because the eight-domain pixel structure has defects such as high cost and low transmittance, the prior art generally adopts the four-domain pixel structure with a VAC adjustment method based on brightness parameters. That is, original pixel grayscale values of two adjacent pixel areas are replaced by two relatively high (H) and relatively low (L) grayscales, which satisfies a brightness relationship: original brightness=(brightness corresponding to the relatively high grayscale+brightness corresponding to the relatively low grayscale)/2. This ensures that a relationship between brightness and grayscale of a side viewing angle is corrected without changing a relationship between brightness and grayscale of a front viewing angle.

Currently, a high and low grayscale (HL) compensation algorithm is usually performed on a grayscale of each sub-pixel of RGB to improve a quality of wide viewing angles. FIG. 1A illustrates a high and low grayscale compensation table (HL table or HL compensation table) in the prior art. An original grayscale value of each sub-pixel corresponds to a pair of high grayscale value H and low grayscale value L. The high grayscale value H is greater than the original grayscale value. The low grayscale value L is less than the original grayscale value. Both the high grayscale value H and the low grayscale value L have polarities. A combination of high and low 2 will cause a serious grainy appearance.

In order to reduce the grainy appearance, HL processing may be performed on sub-pixels simultaneously in space and time. FIG. 1B is a schematic diagram of a timing of corresponding high and low grayscale compensation data of sub-pixel compensation in the prior art. According to the HL compensation table and the timing (F1 to F4), HL processing is performed on the sub-pixels simultaneously in space and time. However, when VAC adjustment is performed from frame to frame, in a process of converting the original grayscale value of each sub-pixel into the high grayscale value H/the low grayscale value L, if polarity changes of the high grayscale value H and the low grayscale value L are asymmetrical, the grainy appearance will occur. For example, in a pure grayscale image, when upper and lower adjacent sub-pixels of a display panel changes from frame to frame, the polarity changes of the high grayscale value H and the low grayscale value L are asymmetrical. As a result, a display screen is prone to vertical lines, which in turn leads to a grainy appearance on the display panel. On the other hand, when a refresh frequency of a display panel of a display device is 120 Hz, sub-pixels of the display panel are converted from frame to frame, and brightness of each frame is different, an image will not flicker when only two frames are converted to each other, and the image will flicker when more than two frames with different brightness are converted to each other.

Therefore, it is necessary to provide a display panel, and a method and a device for pixel compensation thereof to overcome the aforementioned drawbacks.

A current large-size VA type liquid crystal display panel adopts a four-domain pixel structure with view angle compensation technology. When a high grayscale value H and a low grayscale value L are converted from frame to frame, polarity changes of the high grayscale value H and the low grayscale value L are asymmetrical, resulting in a grainy appearance on the display panel of the display device, which affects quality of the panel.

### SUMMARY OF DISCLOSURE

The present disclosure provides a display panel, and a method and a device for pixel compensation thereof to solve the following technical problem. A current large-size VA type liquid crystal display panel adopts a four-domain pixel structure with view angle compensation technology. When a high grayscale value H and a low grayscale value L are converted from frame to frame, polarity changes of the high grayscale value H and the low grayscale value L are asymmetrical, resulting in a grainy appearance on the display panel of the display device, which affects quality of the panel.

In order to achieve the aforementioned purpose, embodiments of the present invention adopt the following technical solutions.

The present disclosure provides a method for pixel compensation of a display panel, comprising:

S10: receiving a signal of a frame of image, wherein the signal comprises grayscale data of a plurality of sub-pixels;

S20: obtaining grayscale compensation data of each of the sub-pixels; and

S30: compensating the grayscale data of the sub-pixels according to the grayscale compensation data;

wherein in a time period unit, the grayscale compensation data of each of the sub-pixels comprise high grayscale compensation data and low grayscale compensation data, respective polarities of the high grayscale compensation data and the low grayscale compensation data remain symmetrical, and a number of the high grayscale compensation data is equal to a number of the low grayscale compensation data.

In the method for the pixel compensation of the display panel provided by the present disclosure, the grayscale compensation data of each of the sub-pixels comprise a grayscale compensation data repeating unit, the grayscale compensation data repeating unit comprises n pieces of the high grayscale compensation data and the low grayscale compensation data, and n is an even number greater than zero.

In the method for the pixel compensation of the display panel provided by the present disclosure, n≤f/30, and f is a refresh frequency of the display panel.

In the method for the pixel compensation of the display panel provided by the present disclosure, in the S10, the grayscale data of each of the sub-pixels are grayscale data of a red sub-pixel, grayscale data of a green sub-pixel, or grayscale data of a blue sub-pixel.

In the method for the pixel compensation of the display panel provided by the present disclosure, the S20 comprises:

S21, querying a preset compensation table set comprising a plurality of grayscale compensation tables according to the grayscale data of each of the sub-pixels; and

S22, using the queried result as the obtained grayscale compensation data of the sub-pixels, wherein in the time period unit, an average brightness of a display brightness of the sub-pixels compensated by the high grayscale compensation data and a display brightness of the subpixels compensated by the low grayscale compensation data is a display brightness of the grayscale data of the sub-pixels.

In the method for the pixel compensation of the display panel provided by the present disclosure, the S21 comprises:

establishing a first index relationship for compensation values of each of the grayscale compensation tables according to a time order to obtain first index values; and

establishing a second index relationship for the compensation values of each of the grayscale compensation tables according to grayscale values to obtain second index values;

wherein in the grayscale compensation tables, each combination of one of the first index values and one of the second index values corresponds to one of the high grayscale compensation data and one of the low grayscale compensation data.

In the method for the pixel compensation of the display panel provided by the present disclosure, when each of the sub-pixels has different grayscale data, the corresponding high grayscale compensation data have different values, and the corresponding low grayscale compensation data have different values.

In the method for the pixel compensation of the display panel provided by the present disclosure, when the sub-pixels that are different from each other have the same grayscale data, the corresponding high grayscale compensation data have different values, and the corresponding low grayscale compensation data have different values.

The present disclosure further provides a method for pixel compensation of a display panel, comprising:

S10, receiving a signal of a frame of image, wherein the signal comprises grayscale data of a plurality of sub-pixels;

S20, obtaining grayscale compensation data of each of the sub-pixels; and

S30, compensating the grayscale data of the sub-pixels according to the grayscale compensation data;

wherein in a time period unit, the grayscale compensation data of each of the sub-pixels comprise high grayscale compensation data and low grayscale compensation data, respective polarities of the high grayscale compensation data and the low grayscale compensation data remain symmetrical, and a number of the high grayscale compensation data is equal to a number of the low grayscale compensation data; and

wherein the high grayscale compensation data comprise positive polarity high grayscale compensation data and negative polarity high grayscale compensation data, the low grayscale compensation data comprise positive polarity low grayscale compensation data and negative polarity low grayscale compensation data, a number of the positive polarity high grayscale compensation data is equal to a number of the negative polarity high grayscale compensation data, and a number of the positive polarity low grayscale compensation data is equal to a number of the negative polarity low grayscale compensation data.

In the method for the pixel compensation of the display panel provided by the present disclosure, the grayscale compensation data of each of the sub-pixels comprise a grayscale compensation data repeating unit, the grayscale compensation data repeating unit comprises n pieces of the high grayscale compensation data and the low grayscale compensation data, and n is an even number greater than zero.

In the method for the pixel compensation of the display panel provided by the present disclosure, n≤f/30, and f is a refresh frequency of the display panel.

In the method for the pixel compensation of the display panel provided by the present disclosure, in the S10, the grayscale data of each of the sub-pixels are grayscale data of a red sub-pixel, grayscale data of a green sub-pixel, or grayscale data of a blue sub-pixel.

In the method for the pixel compensation of the display panel provided by the present disclosure, the S20 comprises:

S21, querying a preset compensation table set comprising a plurality of grayscale compensation tables according to the grayscale data of each of the sub-pixels; and

S22, using the queried result as the obtained grayscale compensation data of the sub-pixels, wherein in the time period unit, an average brightness of a display brightness of the sub-pixels compensated by the high grayscale compensation data and a display brightness of the subpixels compensated by the low grayscale compensation data is a display brightness of the grayscale data of the sub-pixels.

In the method for the pixel compensation of the display panel provided by the present disclosure, the S21 comprises:

establishing a first index relationship for compensation values of each of the grayscale compensation tables according to a time order to obtain first index values; and

establishing a second index relationship for the compensation values of each of the grayscale compensation tables according to grayscale values to obtain second index values;

wherein in the grayscale compensation tables, each combination of one of the first index values and one of the second index values corresponds to one of the high grayscale compensation data and one of the low grayscale compensation data.

In the method for the pixel compensation of the display panel provided by the present disclosure, when each of the sub-pixels has different grayscale data, the corresponding high grayscale compensation data have different values, and the corresponding low grayscale compensation data have different values.

In the method for the pixel compensation of the display panel provided by the present disclosure, when the sub-pixels that are different from each other have the same grayscale data, the corresponding high grayscale compensation data have different values, and the corresponding low grayscale compensation data have different values.

The present disclosure further provides a device for pixel compensation of a display panel, comprising:

a receiving unit configured for receiving a signal of an image to be displayed, wherein the signal comprises grayscale data of a plurality of sub-pixels;

a compensation query unit connected to the receiving unit and configured for querying a preset compensation table set comprising a plurality of grayscale compensation tables to obtain high grayscale compensation data and low grayscale compensation data corresponding to the grayscale data of each of the sub-pixels;

a compensation processing unit connected to the compensation query unit and configured for alternately compensating the grayscale data of each of the sub-pixels with the high grayscale compensation data and the low grayscale compensation data according to a time order, wherein polarities of the grayscale compensation data of two adjacent sub-pixels are opposite in the signal of the image in a same frame, the grayscale compensation data of each of the sub-pixels comprise high grayscale compensation data and low grayscale compensation data in a time period unit, respective polarities of the high grayscale compensation data and the low grayscale compensation data remain symmetrical, and a number of the high grayscale compensation data is equal to a number of the low grayscale compensation data; and

a driving unit connected to the compensation processing unit and configured for driving the pixels of the display for display according to the compensated signal.

In the device for the pixel compensation of the display panel provided by the present disclosure, the high grayscale compensation data comprise positive polarity high grayscale compensation data and negative polarity high grayscale compensation data, the low grayscale compensation data comprise positive polarity low grayscale compensation data and negative polarity low grayscale compensation data, a number of the positive polarity high grayscale compensation data is equal to a number of the negative polarity high grayscale compensation data, a number of the positive polarity low grayscale compensation data is equal to a number of the negative polarity low grayscale compensation data, the grayscale compensation data of each of the sub-pixels comprise a grayscale compensation data repeating unit, the grayscale compensation data repeating unit comprises n pieces of the high grayscale compensation data and the low grayscale compensation data, n is an even number greater than zero, n≤f/30, and f is a refresh frequency of the display panel.

In the device for the pixel compensation of the display panel provided by the present disclosure, when each of the sub-pixels has different grayscale data, the corresponding high grayscale compensation data have different values, and the corresponding low grayscale compensation data have different values. The present disclosure further provides a display panel comprising a memory and a controller. The memory is configured for storing program instructions. The controller is configured for executing the program instructions to implement the aforementioned method for the pixel compensation of the aforementioned display panel.

In the method for the pixel compensation of the display panel provided by the present disclosure, from frame to frame, the respective polarities of the high grayscale compensation data and the low grayscale compensation data corresponding to the grayscale data of the sub-pixels of the display panel remain symmetrical, and the number of the high grayscale compensation data is equal to the number of the low grayscale compensation data. As a result, there will be a short-term balance between the adjacent sub-pixels from the high grayscale compensation data to original grayscale data and from the low grayscale compensation data to the original grayscale data, so that there is no obvious brightness change in the image. The method can prevent vertical lines from appearing on the image and effectively eliminate grainy appearance of the display panel. The method can also determine a bright-dark conversion sequence of the grayscale compensation data of each of the sub-pixels that can eliminate the grainy appearance of the display panel when the refresh frequency of the display panel is known.

### BRIEF DESCRIPTION OF DRAWINGS

FIG. 1A is a high and low grayscale compensation table for sub-pixel compensation in the prior art.

FIG. 1B is a schematic diagram of a timing of corresponding high and low grayscale compensation data for the sub-pixel compensation in the prior art.

FIG. 2 is a flowchart of a method for pixel compensation of a display panel of the present invention.

FIG. 3A is a high and low grayscale compensation table for sub-pixel compensation according to a first embodiment of the present invention.

FIG. 3B is a schematic diagram of a timing of corresponding high and low grayscale compensation data for the sub-pixel compensation according to the first embodiment of the present invention.

FIG. 4A is a high and low grayscale compensation table for sub-pixel compensation according to a second embodiment of the present invention.

FIG. 4B is a schematic diagram of a timing of corresponding high and low grayscale compensation data for the sub-pixel compensation according to the second embodiment of the present invention.

FIG. 5 is a structural block diagram of a device for pixel compensation of a display panel of the present invention.

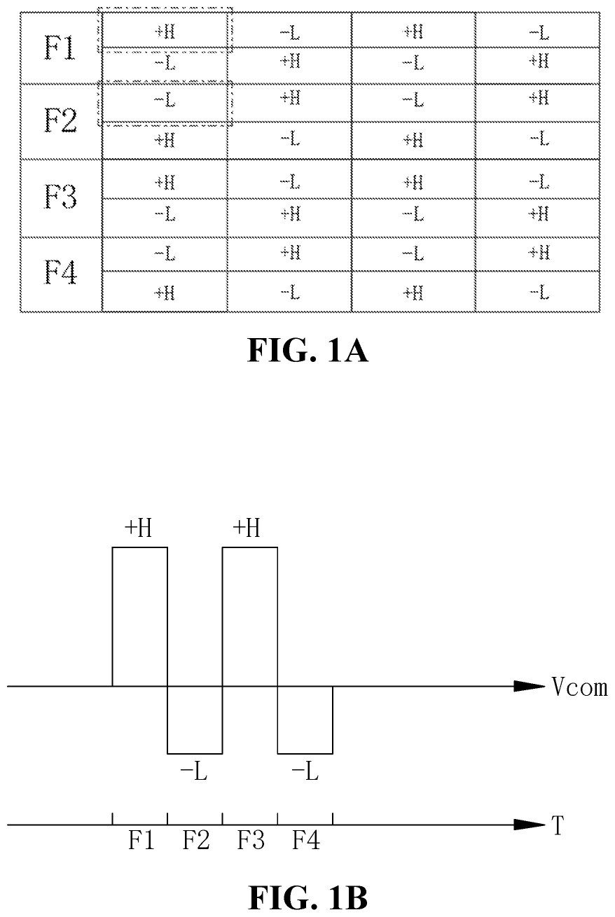

### DETAILED DESCRIPTION

The embodiments of the present invention can solve the following technical problems. A current large-size VA type liquid crystal display panel adopts a four-domain pixel structure with view angle compensation technology. When a high grayscale value H and a low grayscale value L are converted from frame to frame, polarity changes of the high grayscale value H and the low grayscale value L are asymmetrical, resulting in a grainy appearance on the display panel of the display device, which affects quality of the panel.

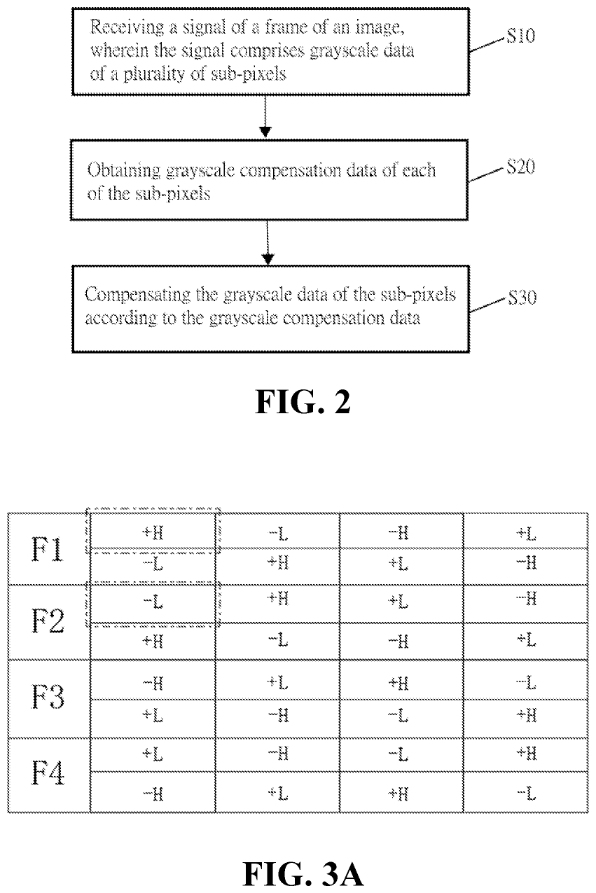

Please refer to FIG. 2, the present disclosure provides a method for pixel compensation of a display panel. The method comprises the following steps.

S10: receiving a signal of a frame of image, wherein the signal comprises grayscale data of a plurality of sub-pixels.

Specifically, the S10 further comprises: first reading the signal of the frame of image, wherein the signal comprises grayscale data of a plurality of sub-pixels, and the grayscale data of each of the sub-pixels are grayscale data of a red sub-pixel, grayscale data of a green sub-pixel, or grayscale data of a blue sub-pixel.

It should be noted that a frame of image is usually composed of multiple pixels. Each of the pixels comprises three primary color components of red (R), green (G), and blue (B), also known as sub-pixels. When driving to display a frame of image, each primary color component of each pixel is provided with a grayscale data required for display to control brightness of each primary color component and make each primary color component display a corresponding color, thereby realizing image display. A VAC adjustment method comprises adding relatively high grayscale data H to grayscale data corresponding to a certain primary color component (R, G, or B) of a certain pixel to replace original grayscale data, and in an adjacent pixel, replacing the original grayscale data with the grayscale data corresponding to the aforementioned primary color component plus a relatively low grayscale data L. Corresponding brightness after compensation by the relatively high grayscale data H plus corresponding brightness after compensation by the relatively low grayscale data L is equal to twice brightness corresponding to the original grayscale data.

It should be noted that a relationship between grayscale and brightness is not linear, but a curve close to Gamma 2.2.

It should be noted that a root cause of subjective grainy appearance is a difference in grayscale. Compensation performed by high grayscale compensation data H and low grayscale compensation data L of VAC adjustment causes a greater difference in brightness value, resulting in bright and dark effects, i.e., the grainy appearance, which affects quality of the panel.

S20: obtaining grayscale compensation data of each of the sub-pixels.

Specifically, the S20 further comprises: first querying a preset compensation table set comprising a plurality of grayscale compensation tables according to the grayscale data of each of the sub-pixels, wherein the compensation table set is composed of the plurality of grayscale compensation tables obtained by the adjustment; establishing a first index relationship for compensation values of each of the grayscale compensation tables according to a time order to obtain first index values; and establishing a second index relationship for the compensation values of each of the grayscale compensation tables according to grayscale values to obtain second index values.

Specifically, in the grayscale compensation tables, each combination of one of the first index values and one of the second index values corresponds to one of the high grayscale compensation data H and one of the low grayscale compensation data L. That is, a time of each frame in each grayscale compensation table is provided with a pair of the high grayscale compensation data H and the low grayscale compensation data L corresponding to the corresponding grayscale data.

Preferably, when each of the sub-pixels has different grayscale data, the corresponding high grayscale compensation data H have different values, and the corresponding low grayscale compensation data L have different values. For example, when a red sub-pixel R has a grayscale of 128, a corresponding high grayscale compensation data H is 184, and a corresponding low grayscale compensation data L is 72. When the same red sub-pixel R has the grayscale of 100, the corresponding high grayscale compensation data H is 170, and the corresponding low grayscale compensation data L is 60.

Preferably, when the sub-pixels that are different from each other have the same grayscale data, the corresponding high grayscale compensation data H have different values, and the corresponding low grayscale compensation data L have different values. For example, when the red sub-pixel R has the grayscale of 128, the corresponding high grayscale compensation data H is 184, and the corresponding low grayscale compensation data L is 72. When a green sub-pixel G has a grayscale of 128, a corresponding high grayscale compensation data H is 180, and a corresponding low grayscale compensation data L is 69.

S30: compensating the grayscale data of the sub-pixels according to the grayscale compensation data.

Specifically, the S30 further comprises: in a time period unit, the grayscale compensation data of each of the sub-pixels comprise high grayscale compensation data H and low grayscale compensation data L. Respective polarities of the high grayscale compensation data H and the low grayscale compensation data L remain symmetrical, and a number of the high grayscale compensation data H is equal to a number of the low grayscale compensation data L.

Specifically, in the signal of the image in a same frame, polarities of the grayscale compensation data of two adjacent sub-pixels are opposite.

Specifically, the high grayscale compensation data H comprise positive polarity high grayscale compensation data +H and negative polarity high grayscale compensation data −H. The low grayscale compensation data L comprise positive polarity low grayscale compensation data +L and negative polarity low grayscale compensation data −L. A number of the positive polarity high grayscale compensation data +H is equal to a number of the negative polarity high grayscale compensation data −H. A number of the positive polarity low grayscale compensation data +L is equal to a number of the negative polarity low grayscale compensation data −L.

Furthermore, it is necessary to drive the pixels of the display device for display according to the compensated signal, which specifically comprises sending the obtained grayscale compensation value to the display panel. When the display panel displays an image, it can compensate each of the sub-pixels according to the corresponding grayscale compensation data of each of the sub-pixels in the image. After the grayscale compensation data are input, the pixels of the display panel are driven to display according to the compensated signal, which can improve uneven brightness of each of the sub-pixels and display quality of the image.

The principle that the above method can eliminate the grainy appearance is as follows. If there is no high and low grayscale data compensation in a time order, each of the sub-pixels at a fixed spatial position is always relatively bright or relatively dark, so that the image will have bright and dark grainy appearance. When the high and low grayscale data compensation is performed, there will be a short-term balance between the adjacent sub-pixels from the high grayscale compensation data H to the original grayscale data and from the low grayscale compensation data L to the original grayscale data, so that there is no obvious brightness change in the image. However, when the high and low grayscale data compensation is performed, the displayed image is prone to vertical lines. In order to overcome this side effect, the respective polarities of the high grayscale compensation data H and the low grayscale compensation data L need to remain symmetrical, and the number of the high grayscale compensation data H and the number of the low grayscale compensation data L need to be equal.

Specifically, the grayscale compensation data of each of the sub-pixels comprise a grayscale compensation data repeating unit. The grayscale compensation data repeating unit comprises n pieces of the high grayscale compensation data and the low grayscale compensation data, and n is an even number greater than zero. For example, when the high and low grayscale data compensation is performed, if the grayscale compensation data repeating unit is HL (a repeating arrangement of continuous sub-pixel bright-dark adjustment), n is 2. If the grayscale compensation data repeating unit is HHLL (a repeating arrangement of continuous sub-pixel bright-bright-dark-dark adjustment), n is 4. If the grayscale compensation data repeating unit is HLLHHL (a repeating arrangement of continuous sub-pixel bright-dark-dark-bright-bright-dark adjustment), n is 6.

Furthermore, in order to ensure that the image does not flicker from frame to frame, n needs to meet a condition that n≤f/30, and f is a refresh frequency of the display panel. This is because when the high and low grayscale data compensation is performed, brightness of the image changes from frame to frame. A frequency at which human eyes can perceive brightness changes is at least 30 Hz. To prevent flicker, a continuous frequency of each of the grayscale compensation data repeating unit is at least 30 Hz.

For example, in a 60 Hz TV display panel, the high and low grayscale data compensation used to eliminate the grainy appearance may use HL (the repeating arrangement of continuous sub-pixel bright-dark adjustment). For example, in a 165 Hz gaming monitor display panel, the high and low grayscale data compensation used to eliminate the grainy appearance may use HL (the repeating arrangement of continuous sub-pixel bright-dark adjustment) or HHLL (the repeating arrangement of continuous sub-pixel bright-bright-dark-dark adjustment).

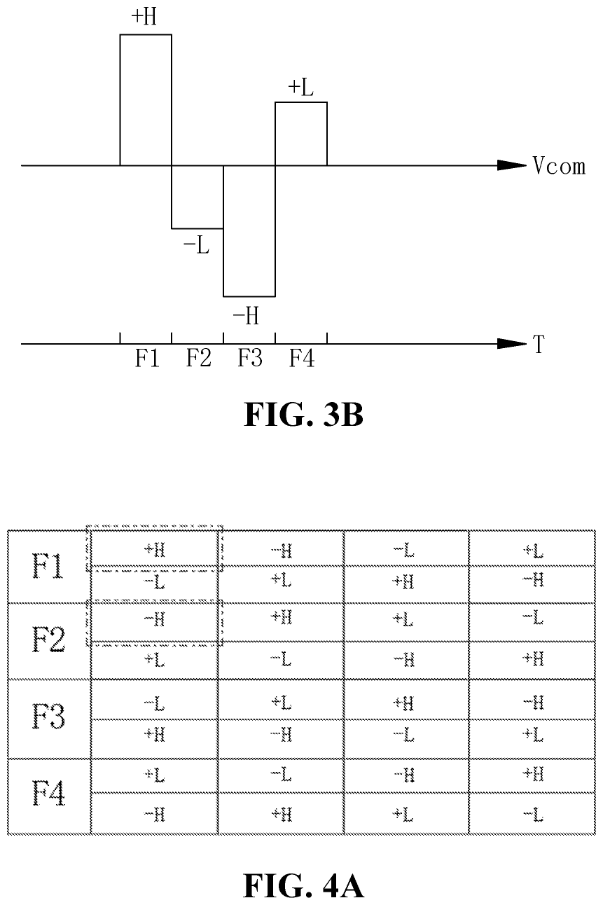

Please refer to FIG. 3A, which is a high and low grayscale compensation table for sub-pixel compensation according to a first embodiment of the present invention. In the grayscale compensation table with a time index provided by the embodiment of the present invention, a first index relationship is established for compensation data according to a time order, and a second index relationship is established for the compensation values according to grayscale values. In the compensation table, each combination of a first index value and a second index value corresponds to a pair of high grayscale compensation data H and low grayscale compensation data L.

The first index relationship is established for the compensation data of each of the grayscale compensation tables according to the time order to obtain the first index values. The second index relationship is established for the compensation data of each of the grayscale compensation tables according to the grayscale data to obtain the second index values.

In FIG. 3A, there are four frames (F1, F2, F3, and F4) in a vertical direction, and 8 adjacent sub-pixels in each of the frames in a horizontal direction. An original grayscale value 0 (not shown and should be shown at a top of each column) of a certain sub-pixel corresponds to a pair of high grayscale compensation data H and low grayscale compensation data L at any time. Any high grayscale compensation data H is greater than or equal to the grayscale data 0. Any low grayscale compensation data L is less than or equal to the grayscale data 0. The high grayscale compensation data H and the low grayscale compensation data L both have polarities, and their polarities remain symmetrical. A number of the high grayscale compensation data H is equal to a number of the low grayscale compensation data L. The polarities of each pair of the high grayscale compensation data H and the low grayscale compensation data L are opposite.

Specifically, the high grayscale compensation data H comprise positive polarity high grayscale compensation data +H and negative polarity high grayscale compensation data −H. The low grayscale compensation data L comprise positive polarity low grayscale compensation data +L and negative polarity low grayscale compensation data −L. A number of the positive polarity high grayscale compensation data +H is equal to a number of the negative polarity high grayscale compensation data −H. A number of the positive polarity low grayscale compensation data +L is equal to a number of the negative polarity low grayscale compensation data −L.

Please refer to FIG. 3B, which is a schematic diagram of a timing of corresponding high and low grayscale compensation data for the sub-pixel compensation according to the first embodiment of the present invention. In the current first frame F1, the sub-pixel is compensated with the positive polarity high grayscale compensation data +H under a certain grayscale data. In the current second frame F2, the sub-pixel is compensated with the negative polarity low grayscale compensation data −L under the same grayscale data. In the current third frame F3, the sub-pixel is compensated with the negative polarity high grayscale compensation data −H under the same grayscale data. In the current fourth frame F4, the sub-pixel is compensated with the positive polarity low grayscale compensation data+L under the same grayscale data.

Specifically, during a process of alternately switching grayscale data corresponding to two adjacent sub-pixels in a frame of image in a time period unit T (the current first frame F1 to the current fourth frame F4), grayscale compensation data of each of the sub-pixels comprise a grayscale compensation data repeating unit. The grayscale compensation data repeating unit comprises one high grayscale compensation data H and one low grayscale compensation data L (n is 2).

Specifically, the respective polarities of the high grayscale compensation data H and the low grayscale compensation data L corresponding to the grayscale data of the sub-pixels remain symmetrical. That is, during a process of alternately switching the high grayscale compensation data H corresponding to the grayscale data of the sub-pixels in the same time period unit T (the current first frame F1 to the current fourth frame F4), a number of the positive polarity high grayscale compensation data +H (1 piece) is equal to a number of the negative polarity high grayscale compensation data −H (1 piece). At the same time, a number of the positive polarity low grayscale compensation data +L (1 piece) is equal to a number of the negative polarity low grayscale compensation data −L (1 piece).

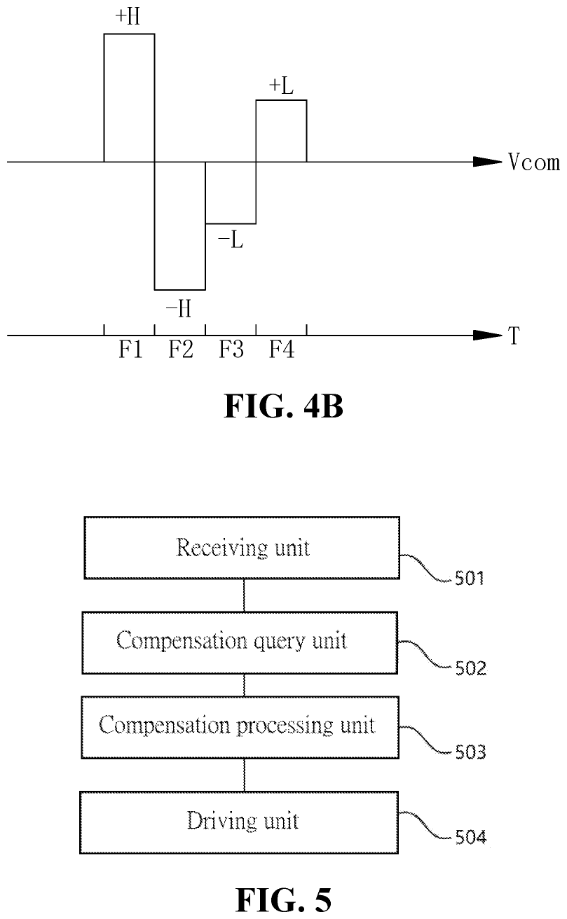

Please refer to FIG. 4A, which is a high and low grayscale compensation table for sub-pixel compensation according to a second embodiment of the present invention. There are four frames (F1, F2, F3, and F4) in a vertical direction, and 8 adjacent sub-pixels in each of the frames in a horizontal direction. An original grayscale value 0 (not shown and should be shown at a top of each column) of a certain sub-pixel corresponds to a pair of high grayscale compensation data H and low grayscale compensation data L at any time. Any high grayscale compensation data H is greater than or equal to the grayscale data 0. Any low grayscale compensation data L is less than or equal to the grayscale data 0. The high grayscale compensation data H and the low grayscale compensation data L both have polarities, and their polarities remain symmetrical. A number of the high grayscale compensation data H is equal to a number of the low grayscale compensation data L. The polarities of each pair of the high grayscale compensation data H and the low grayscale compensation data L are opposite.

Specifically, the high grayscale compensation data H comprise positive polarity high grayscale compensation data +H and negative polarity high grayscale compensation data −H. The low grayscale compensation data L comprise positive polarity low grayscale compensation data +L and negative polarity low grayscale compensation data −L. A number of the positive polarity high grayscale compensation data +H is equal to a number of the negative polarity high grayscale compensation data −H. A number of the positive polarity low grayscale compensation data +L is equal to a number of the negative polarity low grayscale compensation data −L.

Please refer to FIG. 4B, which is a schematic diagram of a timing of corresponding high and low grayscale compensation data for the sub-pixel compensation according to the second embodiment of the present invention. In the current first frame F1, the sub-pixel is compensated with the positive polarity high grayscale compensation data +H under a certain grayscale data. In the current second frame F2, the sub-pixel is compensated with the negative polarity high grayscale compensation data −H under the same grayscale data. In the current third frame F3, the sub-pixel is compensated with the negative polarity low grayscale compensation data −L under the same grayscale data. In the current fourth frame F4, the sub-pixel is compensated with the positive polarity low grayscale compensation data +L under the same grayscale data.

Specifically, during a process of alternately switching grayscale data corresponding to two adjacent sub-pixels in a frame of image in a time period unit T (the current first frame F1 to the current fourth frame F4), grayscale compensation data of each of the sub-pixels comprise a grayscale compensation data repeating unit. The grayscale compensation data repeating unit comprises two high grayscale compensation data H and two low grayscale compensation data L (n is 4).

Specifically, the respective polarities of the high grayscale compensation data H and the low grayscale compensation data L corresponding to the grayscale data of the sub-pixels remain symmetrical. That is, during a process of alternately switching the high grayscale compensation data H corresponding to the grayscale data of the sub-pixels in the same time period unit T (the current first frame F1 to the current fourth frame F4), a number of the positive polarity high grayscale compensation data +H (1 piece) is equal to a number of the negative polarity high grayscale compensation data −H (1 piece). At the same time, a number of the positive polarity low grayscale compensation data +L (1 piece) is equal to a number of the negative polarity low grayscale compensation data −L (1 piece).

The first embodiment and the second embodiment of the present invention can eliminate a grainy appearance of the display panel of the display device when switching from frame to frame, and can determine a VAC switching method that eliminates the grainy appearance of the display panel of the display device according to a known refresh frequency of the display device.

Based on the same inventive concept, the present disclosure further provides a device for pixel compensation of a display panel. The device for the pixel compensation of the display panel provided by the present disclosure can be implemented in a timing controller of the display panel.

Please refer to FIG. 5, which is a structural block diagram of a device for pixel compensation of a display panel of the present invention.

The device for the pixel compensation of the display panel comprises:

a receiving unit 501 configured for receiving a signal of an image to be displayed, wherein the signal comprises grayscale data of a plurality of sub-pixels;

a compensation query unit 502 connected to the receiving unit 501 and configured for querying a preset compensation table set comprising a plurality of grayscale compensation tables to obtain high grayscale compensation data H and low grayscale compensation data L corresponding to the grayscale data of each of the sub-pixels, wherein an average brightness of a display brightness of the sub-pixels compensated by the high grayscale compensation data and a display brightness of the subpixels compensated by the low grayscale compensation data is a display brightness of the grayscale data of the sub-pixels;

a compensation processing unit 503 connected to the compensation query unit 502 and configured for alternately compensating the grayscale data of each of the sub-pixels with the high grayscale compensation data H and the low grayscale compensation data L according to a time order, wherein polarities of the grayscale compensation data of two adjacent sub-pixels are opposite in the signal of the image in a same frame, the grayscale compensation data of each of the sub-pixels comprise high grayscale compensation data H and low grayscale compensation data L in a time period unit, respective polarities of the high grayscale compensation data H and the low grayscale compensation data L remain symmetrical, and a number of the high grayscale compensation data H is equal to a number of the low grayscale compensation data L; and

a driving unit 504 connected to the compensation processing unit 503 and configured for driving the pixels of the display for display according to the compensated signal.

The high grayscale compensation data H comprise positive polarity high grayscale compensation data +H and negative polarity high grayscale compensation data −H. The low grayscale compensation data L comprise positive polarity low grayscale compensation data +L and negative polarity low grayscale compensation data −L. A number of the positive polarity high grayscale compensation data +H is equal to a number of the negative polarity high grayscale compensation data −H. A number of the positive polarity low grayscale compensation data +L is equal to a number of the negative polarity low grayscale compensation data −L. The grayscale compensation data of each of the sub-pixels comprise a grayscale compensation data repeating unit. The grayscale compensation data repeating unit comprises n pieces of the high grayscale compensation data H and the low grayscale compensation data L, n is an even number greater than zero, n≤f/30, and f is a refresh frequency of the display panel.

Based on the same inventive concept, the present disclosure further provides a display panel comprising a memory and a controller. The memory is configured for storing program instructions. The controller is configured for executing the program instructions to implement the aforementioned method for the pixel compensation of the aforementioned display panel.

In the above, in the method for the pixel compensation of the display panel provided by the present disclosure, from frame to frame, the respective polarities of the high grayscale compensation data and the low grayscale compensation data corresponding to the grayscale data of the sub-pixels of the display panel remain symmetrical, and the number of the high grayscale compensation data is equal to the number of the low grayscale compensation data. As a result, there will be a short-term balance between the adjacent sub-pixels from the high grayscale compensation data to original grayscale data and from the low grayscale compensation data to the original grayscale data, so that there is no obvious brightness change in the image. The method can prevent vertical lines from appearing on the image and effectively eliminate grainy appearance of the display panel. The method can also determine a bright-dark conversion sequence of the grayscale compensation data of each of the sub-pixels that can eliminate the grainy appearance of the display panel when the refresh frequency of the display panel is known.

In the above embodiments, the description of each embodiment has its own emphasis. For parts not detailed in one embodiment, reference may be made to the related descriptions in other embodiments.

The display panel, and the method and the device for the pixel compensation thereof provided by the embodiments of the present disclosure are described in detail above. The present disclosure uses specific examples to describe principles and embodiments of the present invention. The above description of the embodiments is only for helping to understand technical solutions and core ideas of the present invention. It should be understood by those skilled in the art that they can modify the technical solutions recited in the foregoing embodiments, or replace some of technical features in the foregoing embodiments with equivalents. These modifications or replacements do not cause essence of corresponding technical solutions to depart from the scope of the technical solutions of the embodiments of the present disclosure.

1. A method for pixel compensation of a display panel, comprising:
S10, receiving a signal of a frame of image, wherein the signal comprises grayscale data of a plurality of sub-pixels;
S20, obtaining grayscale compensation data of each of the sub-pixels; and
S30, compensating the grayscale data of the sub-pixels according to the grayscale compensation data;
wherein in a time period unit, the grayscale compensation data of each of the sub-pixels comprise high grayscale compensation data and low grayscale compensation data, respective polarities of the high grayscale compensation data and the low grayscale compensation data remain symmetrical, and a number of the high grayscale compensation data is equal to a number of the low grayscale compensation data.

2. The method for the pixel compensation of the display panel according to claim 1, wherein the grayscale compensation data of each of the sub-pixels comprise a grayscale compensation data repeating unit, the grayscale compensation data repeating unit comprises n pieces of the high grayscale compensation data and the low grayscale compensation data, and n is an even number greater than zero.

3. The method for the pixel compensation of the display panel according to claim 2, wherein n≤f/30, and f is a refresh frequency of the display panel.

4. The method for the pixel compensation of the display panel according to claim 1, wherein in the S10, the grayscale data of each of the sub-pixels are grayscale data of a red sub-pixel, grayscale data of a green sub-pixel, or grayscale data of a blue sub-pixel.

5. The method for the pixel compensation of the display panel according to claim 1, wherein the S20 comprises:
S21, querying a preset compensation table set comprising a plurality of grayscale compensation tables according to the grayscale data of each of the sub-pixels; and
S22, using the queried result as the obtained grayscale compensation data of the sub-pixels, wherein in the time period unit, an average brightness of a display brightness of the sub-pixels compensated by the high grayscale compensation data and a display brightness of the subpixels compensated by the low grayscale compensation data is a display brightness of the grayscale data of the sub-pixels.

6. The method for the pixel compensation of the display panel according to claim 5, wherein the S21 comprises:
establishing a first index relationship for compensation values of each of the grayscale compensation tables according to a time order to obtain first index values; and
establishing a second index relationship for the compensation values of each of the grayscale compensation tables according to grayscale values to obtain second index values;
wherein in the grayscale compensation tables, each combination of one of the first index values and one of the second index values corresponds to one of the high grayscale compensation data and one of the low grayscale compensation data.

7. The method for the pixel compensation of the display panel according to claim 3, wherein when each of the sub-pixels has different grayscale data, the corresponding high grayscale compensation data have different values, and the corresponding low grayscale compensation data have different values.

8. The method for the pixel compensation of the display panel according to claim 3, wherein when the sub-pixels that are different from each other have the same grayscale data, the corresponding high grayscale compensation data have different values, and the corresponding low grayscale compensation data have different values.

9. The method for the pixel compensation of the display panel according to claim 1,
wherein the high grayscale compensation data comprise positive polarity high grayscale compensation data and negative polarity high grayscale compensation data, the low grayscale compensation data comprise positive polarity low grayscale compensation data and negative polarity low grayscale compensation data, a number of the positive polarity high grayscale compensation data is equal to a number of the negative polarity high grayscale compensation data, and a number of the positive polarity low grayscale compensation data is equal to a number of the negative polarity low grayscale compensation data.

10. The method for the pixel compensation of the display panel according to claim 9, wherein the grayscale compensation data of each of the sub-pixels comprise a grayscale compensation data repeating unit, the grayscale compensation data repeating unit comprises n pieces of the high grayscale compensation data and the low grayscale compensation data, and n is an even number greater than zero.

11. The method for the pixel compensation of the display panel according to claim 10, wherein n≤f/30, and f is a refresh frequency of the display panel.

12. The method for the pixel compensation of the display panel according to claim 9, wherein in the S10, the grayscale data of each of the sub-pixels are grayscale data of a red sub-pixel, grayscale data of a green sub-pixel, or grayscale data of a blue sub-pixel.

13. The method for the pixel compensation of the display panel according to claim 9, wherein the S20 comprises:
S21, querying a preset compensation table set comprising a plurality of grayscale compensation tables according to the grayscale data of each of the sub-pixels; and
S22, using the queried result as the obtained grayscale compensation data of the sub-pixels, wherein in the time period unit, an average brightness of a display brightness of the sub-pixels compensated by the high grayscale compensation data and a display brightness of the subpixels compensated by the low grayscale compensation data is a display brightness of the grayscale data of the sub-pixels.

14. The method for the pixel compensation of the display panel according to claim 13, wherein the S21 comprises:
establishing a first index relationship for compensation values of each of the grayscale compensation tables according to a time order to obtain first index values; and
establishing a second index relationship for the compensation values of each of the grayscale compensation tables according to grayscale values to obtain second index values;
wherein in the grayscale compensation tables, each combination of one of the first index values and one of the second index values corresponds to one of the high grayscale compensation data and one of the low grayscale compensation data.

15. The method for the pixel compensation of the display panel according to claim 10, wherein when each of the sub-pixels has different grayscale data, the corresponding high grayscale compensation data have different values, and the corresponding low grayscale compensation data have different values.

16. The method for the pixel compensation of the display panel according to claim 10, wherein when the sub-pixels that are different from each other have the same grayscale data, the corresponding high grayscale compensation data have different values, and the corresponding low grayscale compensation data have different values.

17. A device for pixel compensation of a display panel, comprising:
a receiving unit configured for receiving a signal of an image to be displayed, wherein the signal comprises grayscale data of a plurality of sub-pixels;
a compensation query unit connected to the receiving unit and configured for querying a preset compensation table set comprising a plurality of grayscale compensation tables to obtain high grayscale compensation data and low grayscale compensation data corresponding to the grayscale data of each of the sub-pixels;
a compensation processing unit connected to the compensation query unit and configured for alternately compensating the grayscale data of each of the sub-pixels with the high grayscale compensation data and the low grayscale compensation data according to a time order, wherein polarities of the grayscale compensation data of two adjacent sub-pixels are opposite in the signal of the image in a same frame, the grayscale compensation data of each of the sub-pixels comprise high grayscale compensation data and low grayscale compensation data in a time period unit, respective polarities of the high grayscale compensation data and the low grayscale compensation data remain symmetrical, and a number of the high grayscale compensation data is equal to a number of the low grayscale compensation data; and
a driving unit connected to the compensation processing unit and configured for driving the sub-pixels of the display panel for display according to the compensated signal.

18. The device for the pixel compensation of the display panel according to claim 17, wherein the high grayscale compensation data comprise positive polarity high grayscale compensation data and negative polarity high grayscale compensation data, the low grayscale compensation data comprise positive polarity low grayscale compensation data and negative polarity low grayscale compensation data, a number of the positive polarity high grayscale compensation data is equal to a number of the negative polarity high grayscale compensation data, a number of the positive polarity low grayscale compensation data is equal to a number of the negative polarity low grayscale compensation data, the grayscale compensation data of each of the sub-pixels comprise a grayscale compensation data repeating unit, the grayscale compensation data repeating unit comprises n pieces of the high grayscale compensation data and the low grayscale compensation data, n is an even number greater than zero, n≤f/30, and f is a refresh frequency of the display panel.

19. The device for the pixel compensation of the display panel according to claim 17, wherein when each of the sub-pixels has different grayscale data, the corresponding high grayscale compensation data have different values, and the corresponding low grayscale compensation data have different values.

20. A display panel, comprising:
a memory configured for storing program instructions, and
a controller configured for executing the program instructions to implement the method for the pixel compensation of the display panel according to claim 1.
